(19) United States
(12) Patent Application Publication
(10) Pub. No.: US 2010/0121989 A1
(43) Pub. Date: May 13, 2010

(54) Digi Time Capsule

(76) Inventor: Sherri Lynn Morris, Chapel Hill, NC (US)

Correspondence Address: Sherri Morris, 1110 Jordan Hills, Chapel Hill, NC, 27517, US

(21) Appl. No.: 12/271,559

(22) Filed: Nov. 14, 2008

Related U.S. Application Data
(60) Provisional application No. 60/989,381, filed on Nov. 20, 2007.

(51) Int. Cl. G06F 3/00

(52) U.S. Cl. 710/13

(57) ABSTRACT

The present utility model relates to the field of software for recording and storing thoughts and media. Specifically it relates to a way to capture and store all the parts of a life journey. The present utility model provides one software application with a media center for storing photos, video and audio files, journal, letters for the future, daddy to be section, mommy to be section, time capsule section for capturing world headlines, sports and arts, an old wives tales quiz, month-to-month guided questions, photo editing center, video making center, photo collage center, baby's nursery center and labor and delivery center.

### (a) CROSS-REFEERENCE TO RELATED APPLICATIONS

Not Applicable.

### (b) STATEMENT REGARDING FEDERALLY SPONOSORED RESEARCH OR DEVELOPMENT

Not Applicable.

### (c) THE NAMES OF THE PARTIES TO A JOINT RESEARCH AGREEMENT

Not Applicable.

### (e) INCORPORATION-BY-REFERENCE OF MATERIAL SUBMITTED ON A COMPACT DISC

Not Applicable.

### (f) BACKGROUND OF THE INVENTION

(1) Field of the Invention

The present utility model relates to the field of computer software.

(2) Description of Related Art Including Information Disclosed Under 37CFR 1.97 and 1.98

When a person wants to record the important things about life happenings, they typically have separate parts. For instance, a journal for writing, a photo album for photos, CD's for videos and audio files. It becomes costly and often times parts are lost or scattered. The Digi Time Capsule keeps all parts in one software application. Noting the various sections of the art.

### (g) BRIEF SUMMARY OF THE INVENTION

In accordance with the invention, the software provides hundred's of questions to trigger all 5 senses of the journey. Through different journey's, the software asks journey specific questions, allows users to capture the current world; prices, government, entertainment and economic status. The software also allows users to predict future world happenings and costs. The software interactively allows users to upload dynamic media (video, audio, images), describe feelings and thoughts through the journal section of the software, write letters for the future for their children or grandchildren, take quizzes, create a dynamic family tree, turn their journey into a movie and export their software to an alternate storage device for safe keeping, and eventually pass down to generation after generation.

### (h) BRIEF DESCRIPTION OF THE SEVERAL VIEWS OF THE DRAWING(S)

Exhibit A.

USB Drive that the software is loaded on.

Exhibit B.

Tin casing the usb drive is held in.

FIG. 1.

Software screen shots of the system's main functions according to the present invention and related product lines.

FIG. 1A.

Software system main function icons.

FIG. 1B.

Software system welcome screen.

FIG. 1C.

Software system memories screen.

FIG. 1D.

Software system family tree main screen

FIG. 1E.

Software system media center main screen.

FIG. 2.

Software system Memories center.

FIG. 2A.

Software system Memories center and the categories for related center.

FIG. 2B.

Software system All About Me category of the Memories center.

FIG. 2C.

Software system My Growing Belly category of the Memories center.

FIG. 2D.

Software system Daddy category of the Memories center.

FIG. 2E.

Software system My Baby Showers category of the Memories center.

FIG. 2F.

Software system Baby's Nursery category of the Memories center.

FIG. 2G.

Software system Monthly Updates category of the Memories center.

FIG. 2H.

Software system Pregnancy Journal category of the Memories center.

FIG. 2I.

Software system Old Wives Tales Quiz of the Memories center.

FIG. 2J.

Software system Baby's Arrival category of the Memories center.

FIG. 2K.

Software system The World Around Me category of the Memories center.

FIG. 2L.

Software system Letters for the Future category of the Memories center.

FIG. 3.

Software system screen shots of Creating a Family Tree main screen.

FIG. 3A.

Software system Maintaining Your Family Tree in the Family Tree center.

FIG. 3B.

Software system Adding a Family member to the family tree in the Family Tree center.

FIG. 4.

Software system screen shot of the Media Center main screen.

FIG. 4A.

Software system Uploading Media section of the Media center.

FIG. 4B.

Software system actually uploading media in the Media center.

FIG. 4C.

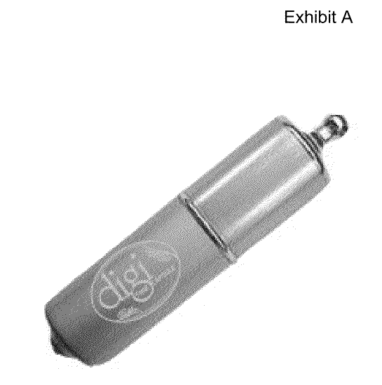

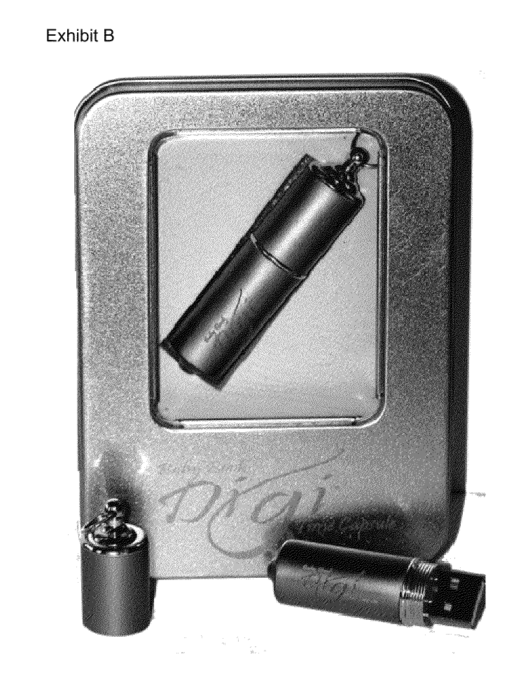

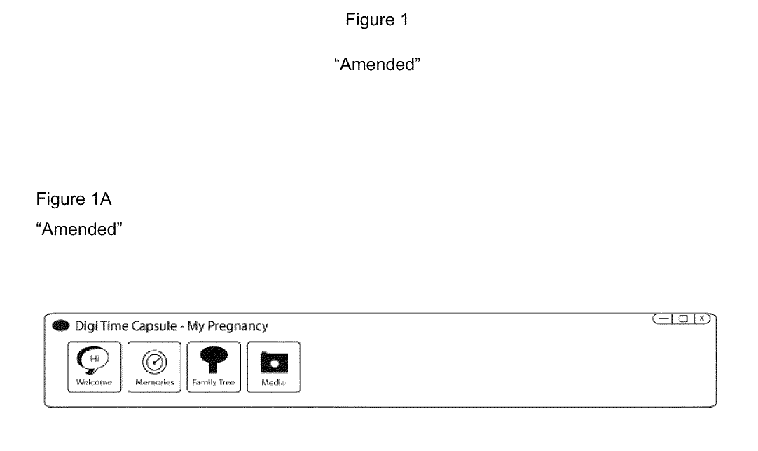

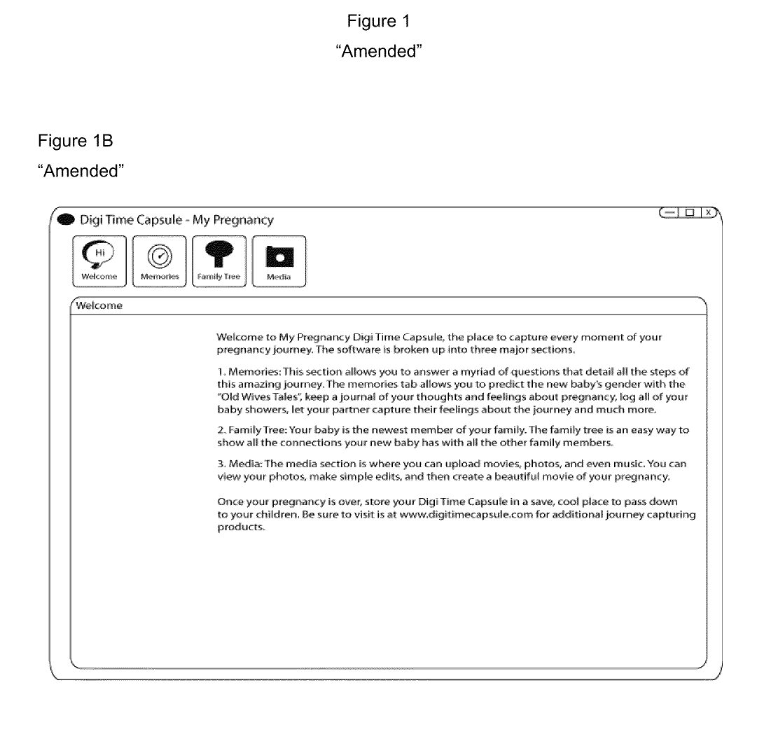

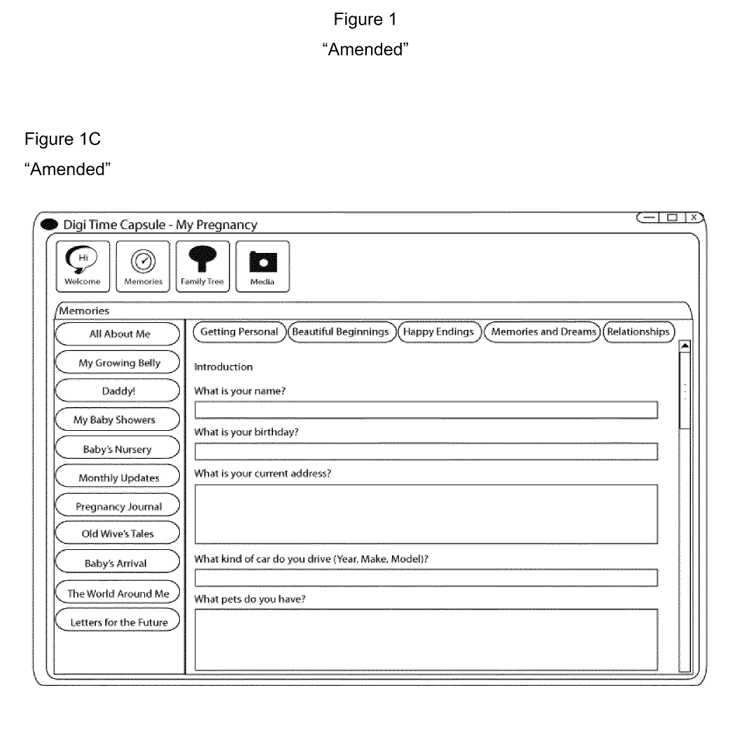

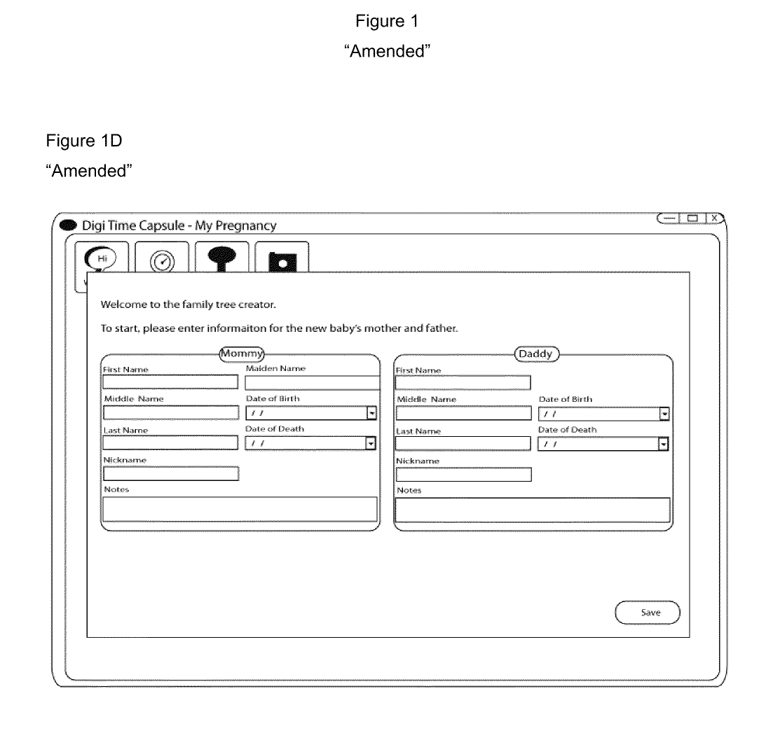

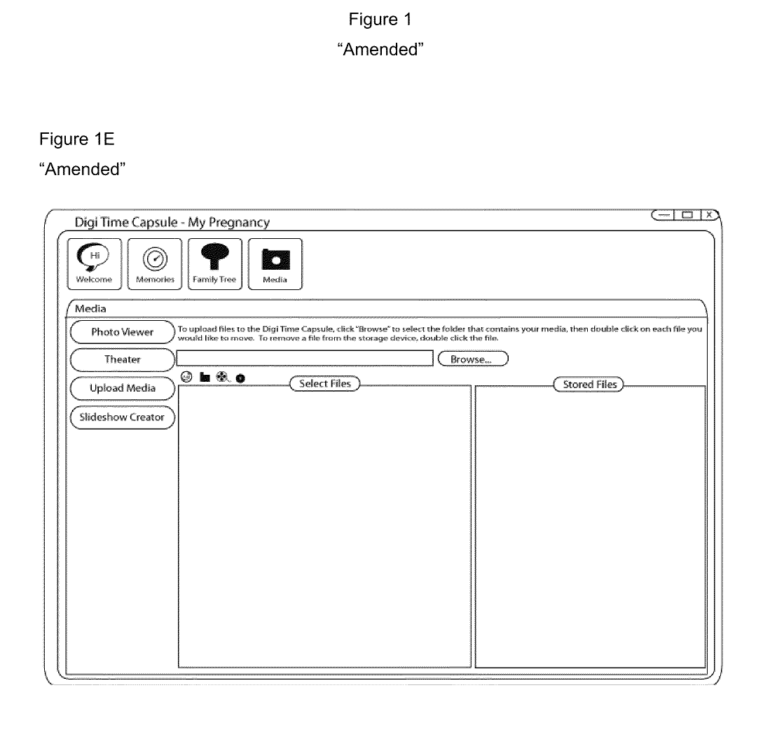

Software system showing available media to choose from in the Media center.

4D.

Software system showing thumbnail images of the media that was uploaded in the Media center.

4E.

Software system showing and uploaded image in the editing mode of the Media center.

4F.

Software system showing a media filed being played in the Media center.

4G.

Software system showing a video being made of uploaded files in the Media center.

### (i) DETAILED DESCRIPTION OF THE INVENTION

Digi Time Capsule is a software tool that captures the present and preserves it for the future.

It is an invention to assist in adding foliage to the family tree; to keeping life's journeys in a safe place to ensure they are passed down in whole and not part to future generations. Users answer 100′s of questions that pertain to the journey they are capturing, upload photos, videos, scanned documents and music. Users can then turn their journey into a video. Users may also export their entire time capsule to alternate storage device or web vault.

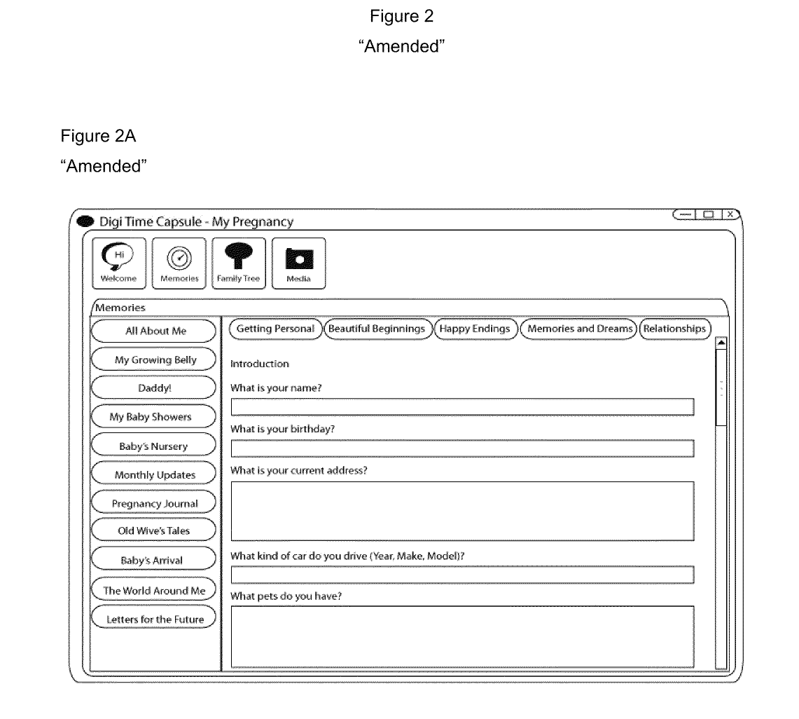

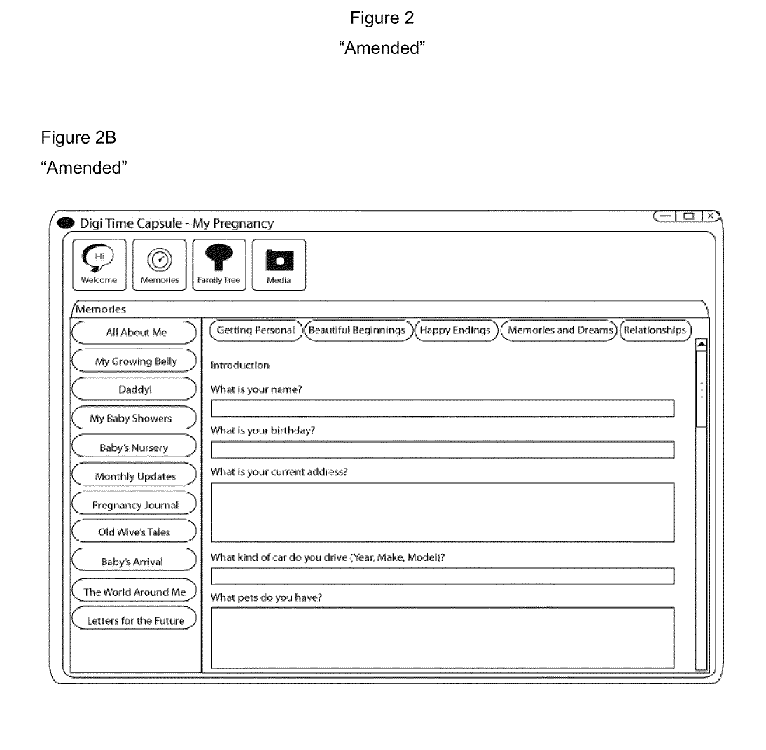

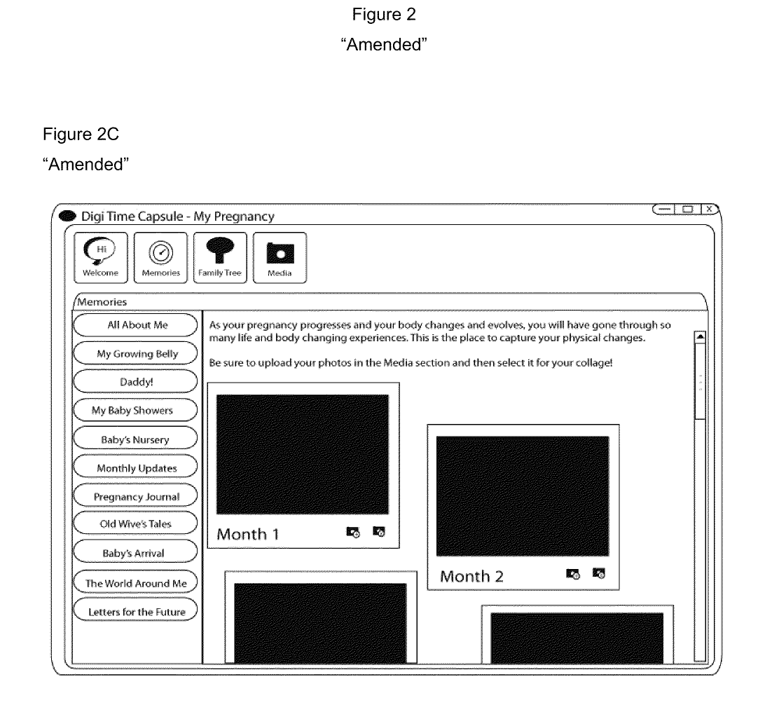

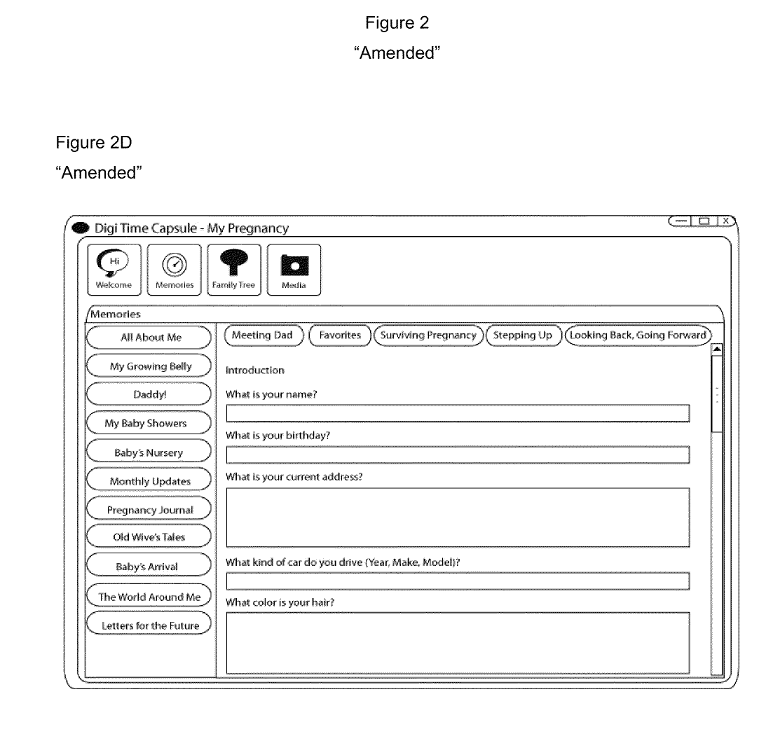

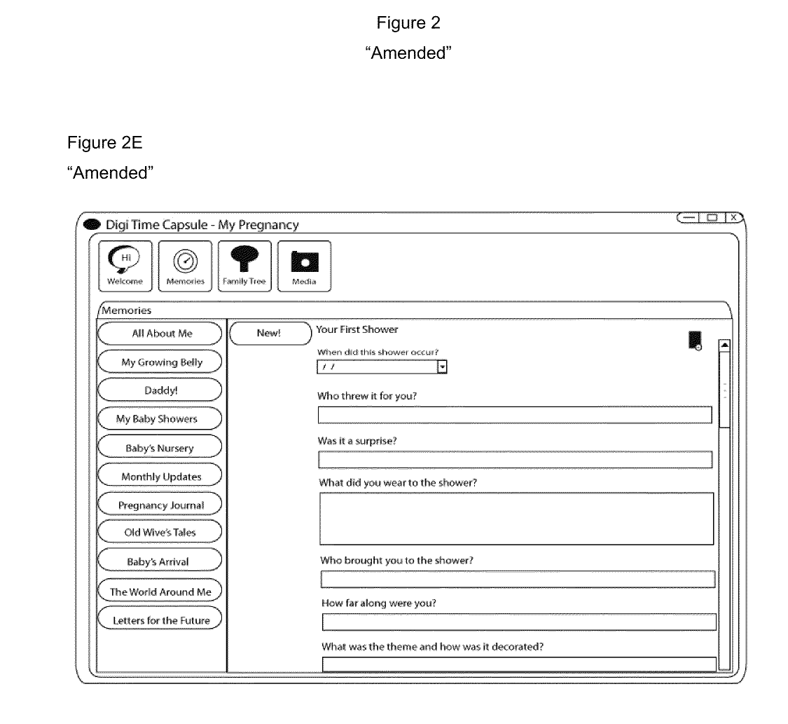

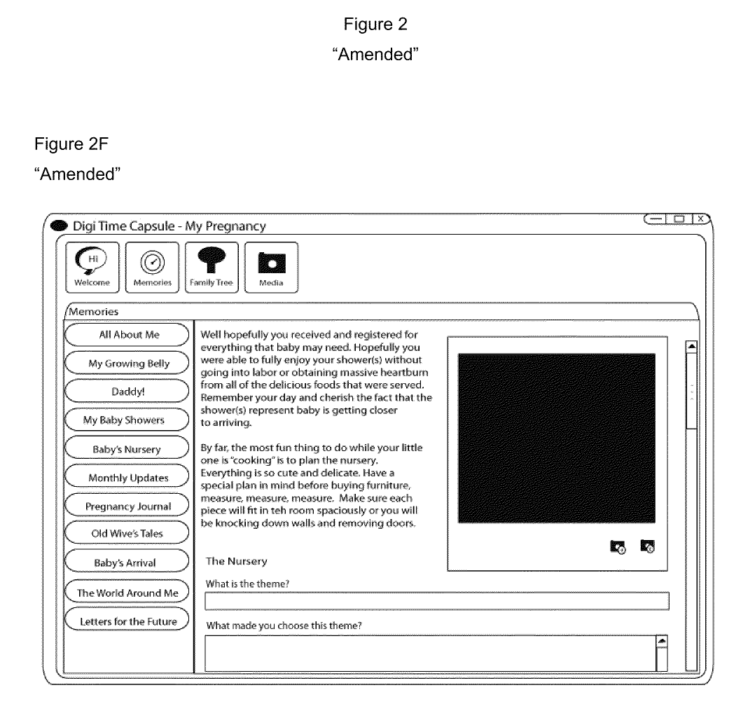

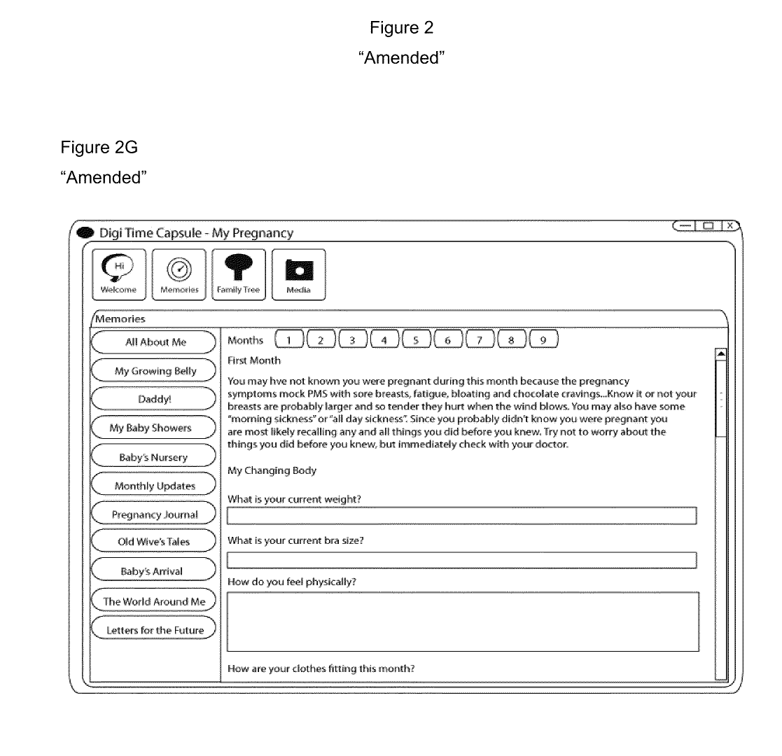

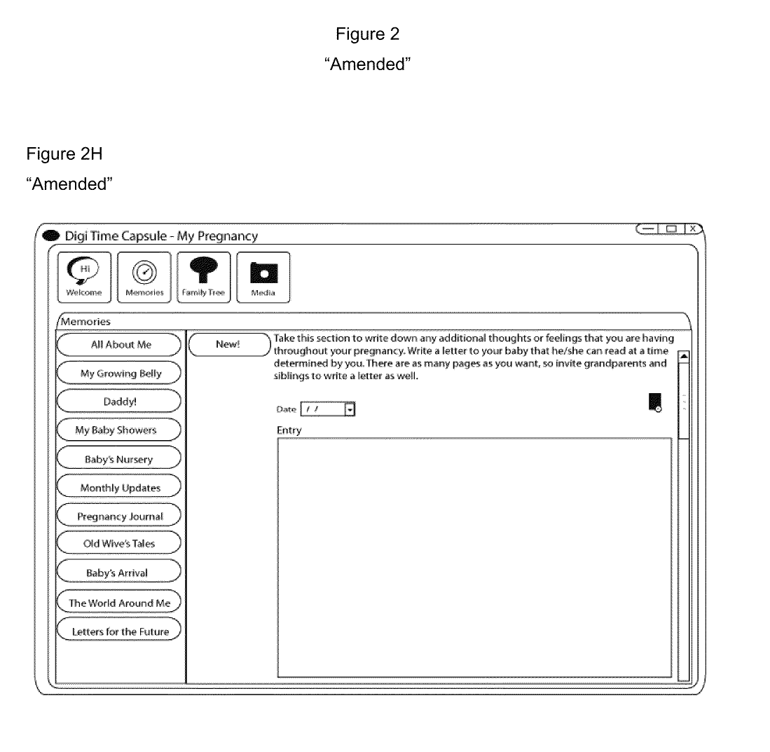

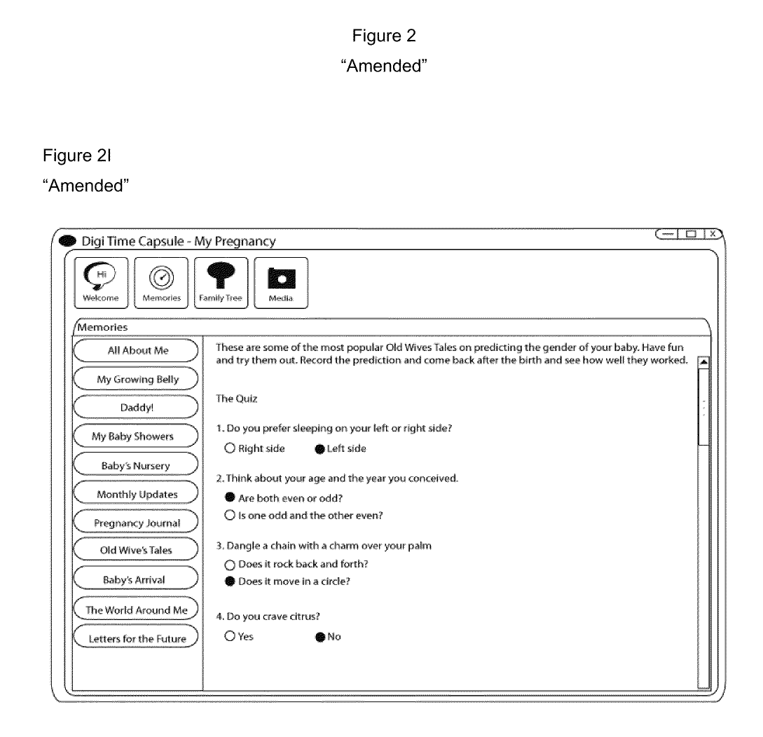

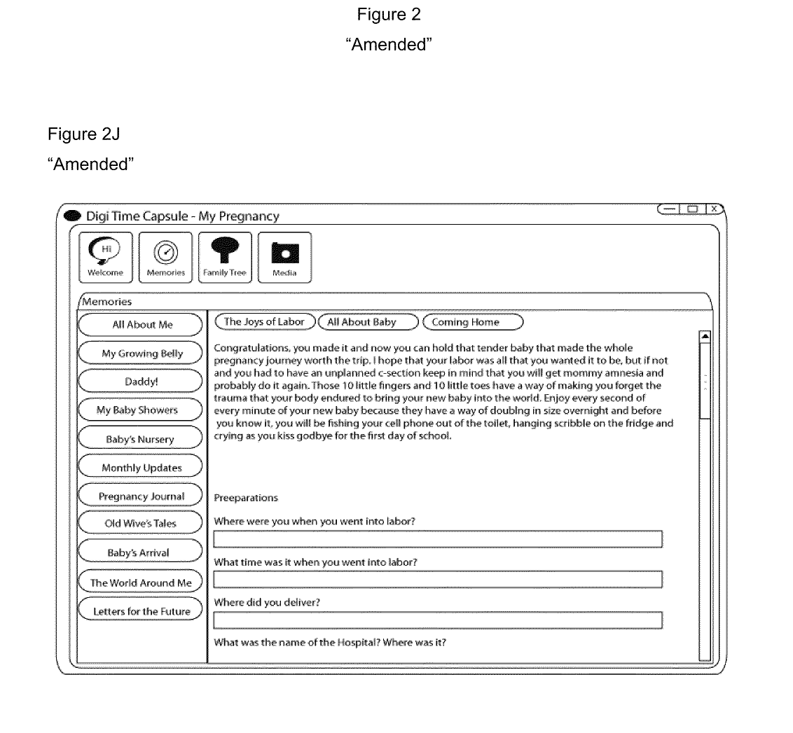

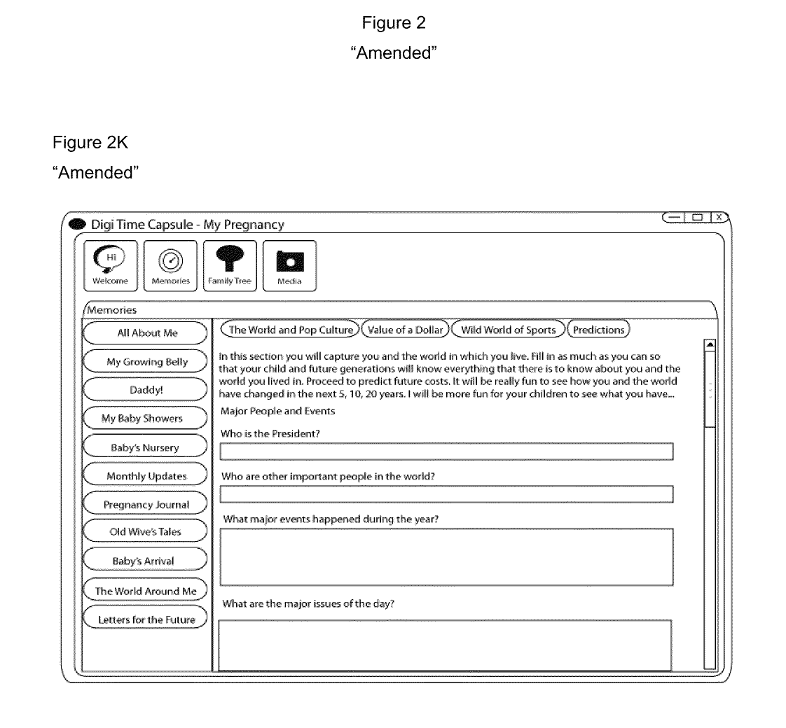

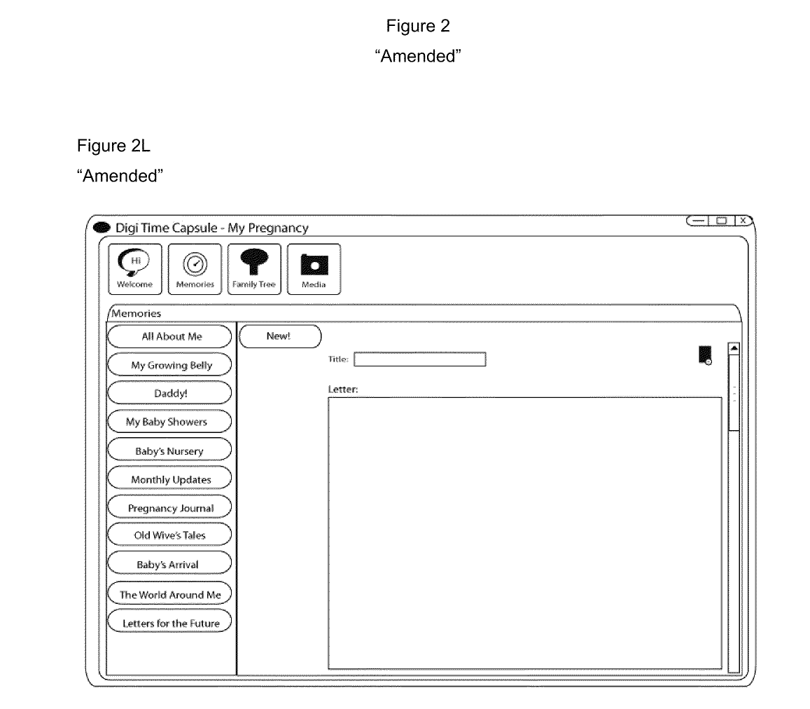

The subject matter of the present invention is particularly pointed out and distinctly claimed in the concluding portion of this specification. However, both to organization and method of operation together with further advantages and objects thereof, may best be understood by reference to the following description taken in connection with accompanying drawings wherein like reference characters refer to like elements. By choosing item 1C Memories icon, Item (A) of FIG. 2 represents the Memories function of the software. The memories function includes main topics (listed along the left column) and subtopics (listed along the top). Each main topic has its own subtopics that directly correlate to the main topic. For example. Main Topic “All About Me” includes subtopics such as getting personal, beautiful beginnings, happy endings, memories and dreams and relationships.

All Main Topics under Memories include the following and will vary based on the present invention and related product lines: All About Me, My Growing Belly, Baby Showers, Daddy, Baby's Nursery, Monthly Updates, Pregnancy Journal, Old Wives Tales Quiz, The World Around Me and Letters for the Future. The following are subtopics and questions that are in each of the Main Topics.

“All About Me” (FIG. 2B): is a text input section with the following subtopics: getting personal, beautiful beginnings, happy endings, memories and dreams and relationships. Questions in this section include: My current address, Where I work and my job title, My best friends are, Social activities I am involved in, What I like to do for fun, My faith is, Kind of car that I drive, What schools did you attend? (Grammar, High School, and College), Languages I speak, Time I usually go to bed, Time I usually wake up, Pets that I currently have, My average day, My talents are, My pet peeves, My current hair color, My eye color, My Height, My pre-pregnancy weight, My post-pregnancy weight, My pre-pregnancy dress size, shoe size, bra size? My post-pregnancy dress size, shoe size, bra size? Type of pregnancy test I took, and how many? My age at conception? When and where do you believe you conceived? Why I thought I might be pregnant? The date I discovered I was pregnant? How I felt when I discovered I was pregnant? My age by my due date? My due date? Who were the first people you told? My favorite things to do in the evening? My favorite restaurants? My favorite place to travel? My favorite food? My favorite color? My favorite song? My favorite sport? My favorite movie? My favorite actor/actress? My favorite TV show? My first car? Age when I wore my first bra? Age when I first got my period? My most embarrassing moment? The dumbest thing I have ever done? The funniest thing I have ever done? My life dreams are? Dream vacation . . . I would really like to . . . Age when I had my first kiss? Name of my first kiss and how it happened? Age when I went on my first date and with who? Where I went on my first date? How I met your dad? We dated for how long before we got married? How long we have been married when you were conceived? Our wedding date is? We were married at? On our honeymoon we went to? My parent's reaction was? My in-laws reaction was? Does baby have any siblings? Sibling's names and ages? How do my other children feel about the pregnancy? Describe your mother's pregnancy with you? Mothering attributes you hope to inherit from your mom? What about the way you were raised will you do differently? What traditions from your childhood will you carry on with your child? What new traditions would you like to do?

My Growing Belly (FIG. 2C): is a photo collage of the changes you physically incur in pregnancy. Users must first upload their photos to the Media section. Users click on a place holder and add a photo of their current month.

Daddy (FIG. 2D): is a text input section for dad to be to capture what he experiences through his partner's pregnancy.

Questions include the following: Your current address? Where you work and your job title? Your best friends are? Social activities you are involved in? What do you like to do for fun? Your faith is? Kind of car that you drive? What schools did you attend? (Grammar, High School, and College)? Languages you speak? Time you usually go to bed? Time you usually wake up? Your average day? Your talents are? Your pet peeves? Your hair color? Your eye color? Your Height? Your favorite things to do in the evening? Your favorite restaurants? Your favorite place to travel? Your favorite food? Your favorite color? Your favorite song? Your favorite sport? Your favorite movie? Your favorite actor/actress? Your favorite TV show? Have you gained any pregnancy weight? Do your partner's moods swing harder than Elvis Presley? How have you handled your partner's mood swings? Does the doctor's office feel like a regular commute? True or False—An SUV is a more practical transportation choice than a new Corvette. Does labor and delivery scare you? Do you plan to cut the cord? Your reaction to finding out your partner was pregnant? Your reaction to hearing baby's heart beat? Your reaction to feeling baby kick? Your reaction to baby's ultrasound? Your reaction to finding out the gender? Do you ever experience sympathy pains in your abdomen? Have you been involved in the design of the nursery? Have you had a say-so on baby's name? Do you have any pregnancy dreams about the baby or delivery? Have you had to give up anything during her pregnancy? Do you love going Baby shopping? How long did it take you to put the crib together and was it an expletive free experience? What about pregnancy comes as a surprise to you? Have you gone through a nesting phase? Explain how you partner has changed during her pregnancy? Who is in the dog house more, you or the dog? Fears you have about being a dad? What are your partner's craziest cravings? What food item have you made/brought home that made your partner “Go Green!”? Something special you do for your partner during her pregnancy? Dad things you are looking forward to doing? If you could, would you change places with your partner? If you could give advice to all future expectant dads, what would it be? Your first car? Your most embarrassing moment? The dumbest thing I have ever done? The funniest thing I have ever done? Your life dreams are . . . ? Dream vacation . . . ? I would really like to . . . ? Fathering attributes you hope to inherit from your dad”? What about the way you were raised will you do differently? What traditions from your childhood will you carry on with your child? What new traditions would you like to do?

Baby Showers (FIG. 2E): is a text input section where users can create and capture as many baby showers as needed to record gifts, food, clothes, friends, place, etc. Users choose the “add entry” selection or the “delete entry” selection.

Baby's Nursery (FIG. 2F): is a text and photo input section where users can capture baby's nursery by uploading a photo of the nursery and answering questions that pertain to the concept, theme and outcome of the nursery. To add a photo, photos must first be loaded to the media section of the software. Users then click on the place holder and select a photo.

“Monthly Updates” (FIG. 2G): is a text input section with the following subtopics: Month 1, Month 2, Month 3, Month 4, Month 5, Month 6, Month 7, Month 8, Month 9 Captures the changes that one goes through month-by-month of her pregnancy. Questions include the following: Today's Date, My current weight? My current bra size? How I feel physically? My overall mood is? My libido is? Frequency of potty breaks? Level of exhaustion? My memory skills are? Changes in my skin, Changes in my hair. Any body aches? Describe what is happening to your body this month. How I feel emotionally. I am feeling anxious about. Your dad is feeling. My other children are feeling. Dreams about my pregnancy. Special treatment I am receiving. Unsolicited advice I have received? Special thoughts about my unborn baby? Names I have been thinking about. Date of doctor visit? Questions I had for the doctor? What was performed at my doctor visit? Advice the doctor gave me? Did I have any Ultrasounds? How I measure? Cravings I have been having? Things I'm doing for a healthy pregnancy? Special activities I did this month? Gifts I have bought for baby? I have tried the following “Old Wives Tales” and it predicts the gender to be? Pregnancy books I am reading? Time I usually go to bed now that I am pregnant? How many naps I need to make it through the day? How many naps I wish I could have to make it through the day? Daily/Nightly pregnancy rituals? Baby's due date? I knew I was pregnant on? How/when we found out? How I felt when I found out? How I told your daddy? Was my pregnancy planned? How long was I trying to conceive? Any certain measures I had to take to conceive? Type of birth you are planning (natural, v-back, c-section)? Are my clothes feeling a bit snug? Foods/Beverages that I use to like that now make me sick? Smells that make me sick? Things I've given up for a healthy pregnancy? Who have I told about my pregnancy? Anyone new that I told this month? Have I told my employer yet? Type of pre-natal vitamins I am taking? Activities I have discontinued doing? First trip to OB/GYN, confirming pregnancy. Total weight gain so far? My favorite thing about being pregnant? My least favorite thing about being pregnant? Anything I really miss from my pre-pregnancy days? Am I showing? Have I begun to wear maternity clothes yet? Any swelling? Any new food or odor deterrents? How I feel about my pregnancy figure? How your daddy feels about my pregnancy figure? Anything new I've given up for a healthy pregnancy? Baby's heart rate? Have I acquired the pregnancy waddle? Where did I purchase my first maternity outfit? Was I able to hear baby's heartbeat? Will I find out the baby's gender before birth? If you could choose, how would you want your delivery day to go? Where are you when contractions start? What time of day is it? What positions would you like to labor in? What position would you like to deliver in? Has anyone that I haven't told asked me if I might be pregnant? Have I felt baby kick yet? Has my energy level picked back up? Has nausea subsided? Have I found out the baby's gender? If so, what is the gender? Have I felt baby hiccup yet? When? Have I created a birth plan? What is my birth plan? Ways I am more cautious because I am pregnant? Does baby have an active kicking period every day? Can your daddy feel you kick? Can I see my belly move when baby kicks? Can others see my belly move when baby kicks? One of the first things I want to do after the baby is born? My favorite maternity outfit? Can I still bend over and tie my shoes? As the baby's Mother, my hopes for baby are? Can others see my belly move when baby kicks? Part of my body that aches the most? What isn't swollen? Am I having Braxton Hicks Contractions? How it feels when baby kicks? Fears about D-day? Did I have any baby showers? My most embarrassing pregnancy mishap? Have I decided to breast or bottle feed? Fears about motherhood? A pregnancy symptom that I really cannot wait to say goodbye to? Has your daddy gained any pregnancy weight? Something I took for granted that was easy to do in my pre-pregnancy days How am I carrying? Where am I carrying most of my pregnancy weight? How fun is shaving my legs now? I have stocked up on the following baby supplies? Have I packed for the hospital yet? What is in my hospital bag? Is the nursery ready? Have I attended any birthing classes? Have I attended any parenting classes? Things I am doing to prepare for your arrival? Can I still see my feet? My current shoe size? What is virtually impossible to do this month? Has baby dropped? What is baby's position in the womb? Am I dilated and how far? How's my level of patience this month? Am I ready for baby? Any false labor trips to the hospital? Am I outgrowing my maternity clothes? Who will be in the room for the birth? Has my pregnancy flown by or dragged on? Am I excited to be done, or will I miss being pregnant? Baby supplies that I still need? Have I chosen a pediatrician? Names I have decided on? Anxieties I am having about D-day? What form of pain control am I considering? Objects I want to make sure I have during labor/delivery? What I plan on wearing on my trip to deliver? I plan on getting to the place of birth by? Help I have arranged for when baby and I go home? If my pregnancy is a planned c-section, what will be my last meal the night before I deliver? Have I been nesting? Date I started my maternity leave?

Pregnancy Journal (FIG. 2H): is a text input section that allows the user to keep a personal journal of thoughts and feelings throughout the pregnancy. User can add as many entries as desired by clicking on the add entry icon or delete previous entries by choose the “delete entry” icon.

Old Wives Tales Quiz (FIG. 2I): fun interactive quiz where users answer questions that best describes their pregnancy. User then clicks “Show Prediction” and the software will predict what the gender of the baby will be.

Baby's Arrival (FIG. 2J): text input section where users capture the birth of their baby.

The World Around Me (FIG. 2K): text input section where users capture the world in which the journey is taking place.

Letters for the Future (FIG. 2L): text input section where users can write and invite others to write letters for the future for the new baby. Users can add as many letters as they wish by choosing the “add entry” icon or delete previous entries by choosing the “delete entries” icon.

In addition to the above mentioned Time Capsule, Digi Time Capsule has a product line in production to include the following Time Capsules:

My Baby Book Digi Time Capsule, My School Year Time Capsule, High School Years Digi Time Capsule, College Years Digi Time Capsule, A Mother's Digi Time Capsule, A Father's Digi Time Capsule, A Grandparent's Digi Time Capsule, My Wedding Digi Time Capsule, My Pet Digi Time Capsule, A Homeowner's Digi Time Capsule, My BFF's Digi Time Capsule; My Family Digi Time Capsule and others that are appropriate for the product line.

Each of the above mentioned Digi Time Capsule products will function in the same way with changes only being in the questions that pertain to the journey. Thus in accordance with the invention, products and benefits that can be associated with and incorporated into the system include: shopping services, baby registry, online referrals, blogs, photo and video galleries, turning your time capsule into a book, e-mailing photos, videos and audio through the system, create birth announcements and wedding invitations.

The overall system is being sold as a stand-alone software product, in separate modules.

While a preferred embodiment of the present invention has been shown and described, it will be apparent to those skilled in the art of software that many changes and modifications may be made without departing from the invention in its broader aspects. The appended claims are therefore intended to cover all such changes and modifications as fall within the true spirit and scope of the invention.

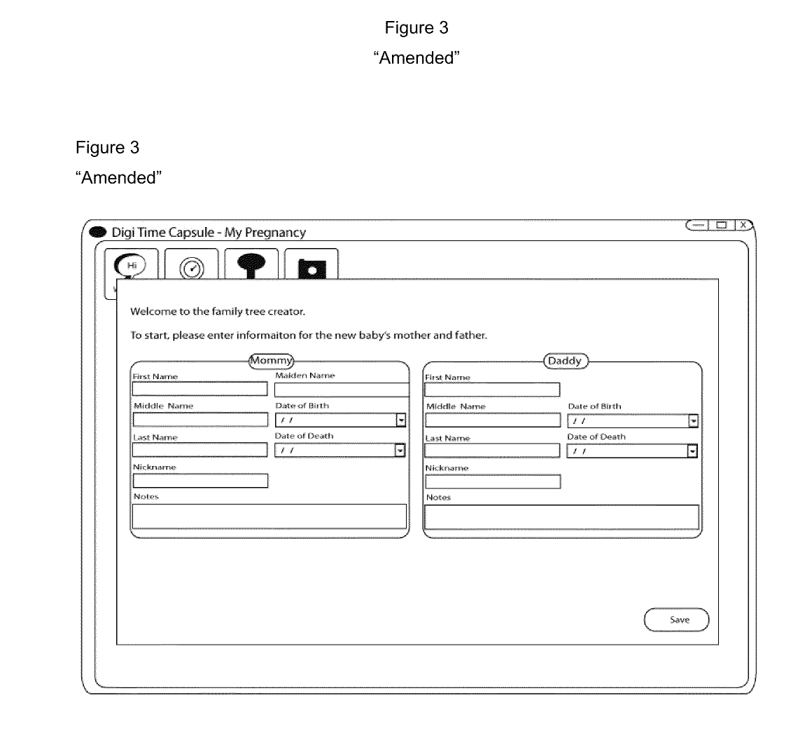

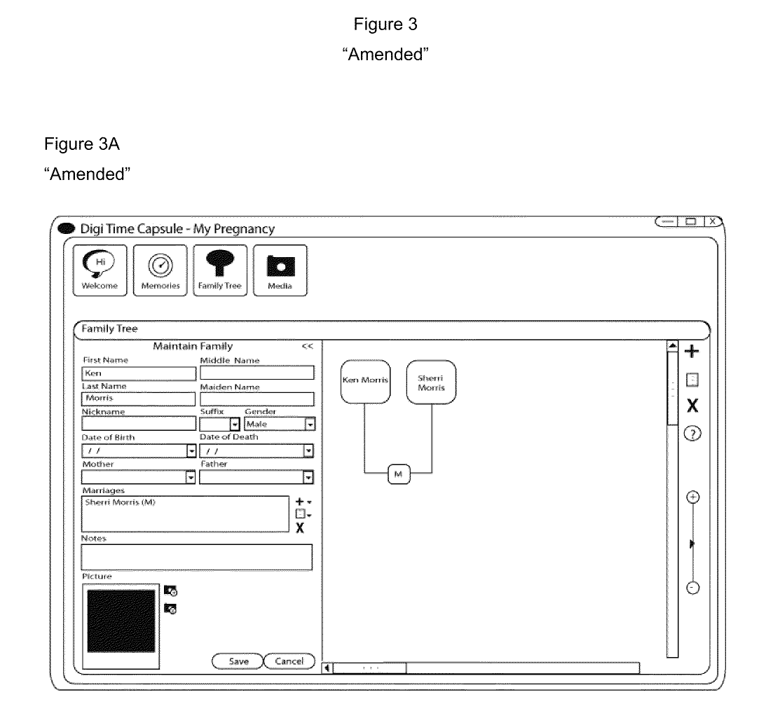

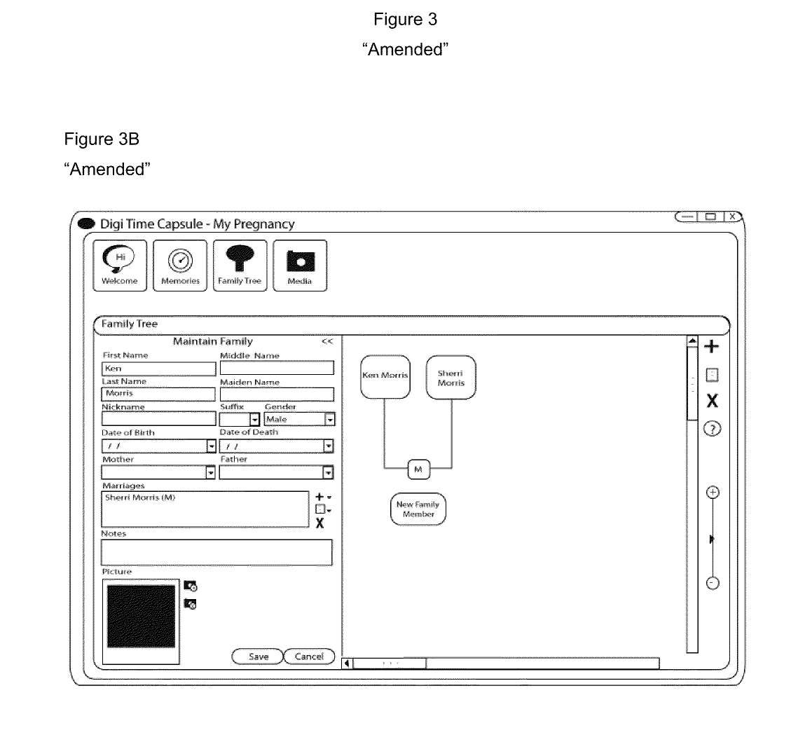

FIG. 3: Allows users to create a family tree for their new baby. User is prompted to enter parent's name. Once user enters the parent's name, user can then double click on a family member (3A) to add a photo or edit that member's information. (3B) To add additional family members, the user chooses “add new member” and is prompted to input the member information such as birth, death and marriage records on as many members as they choose.

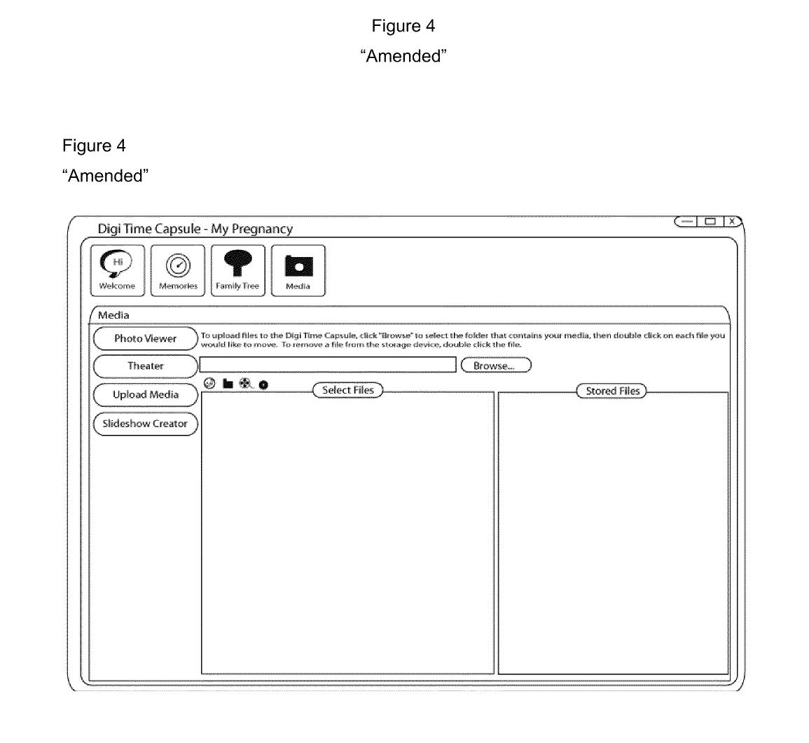

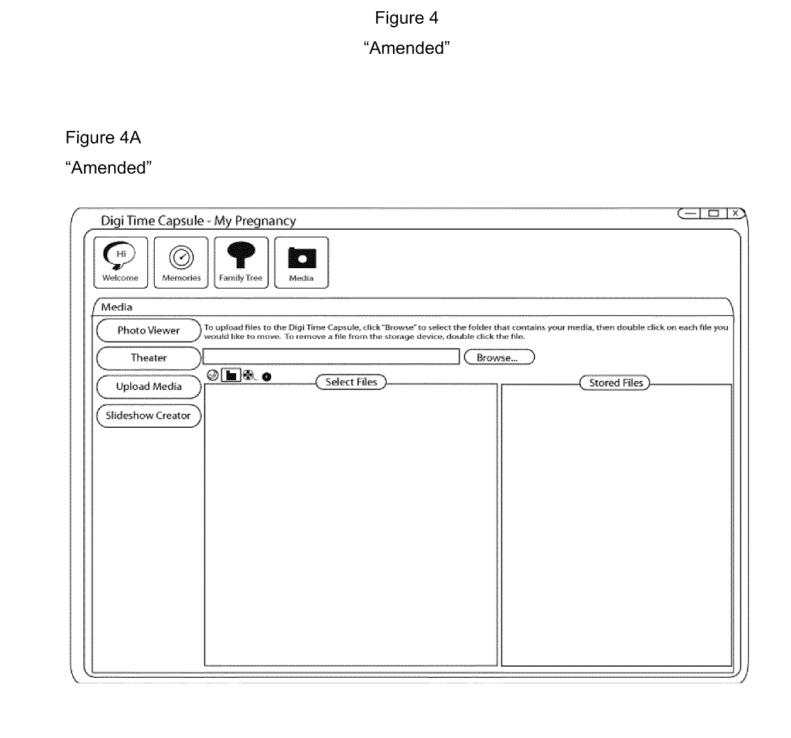

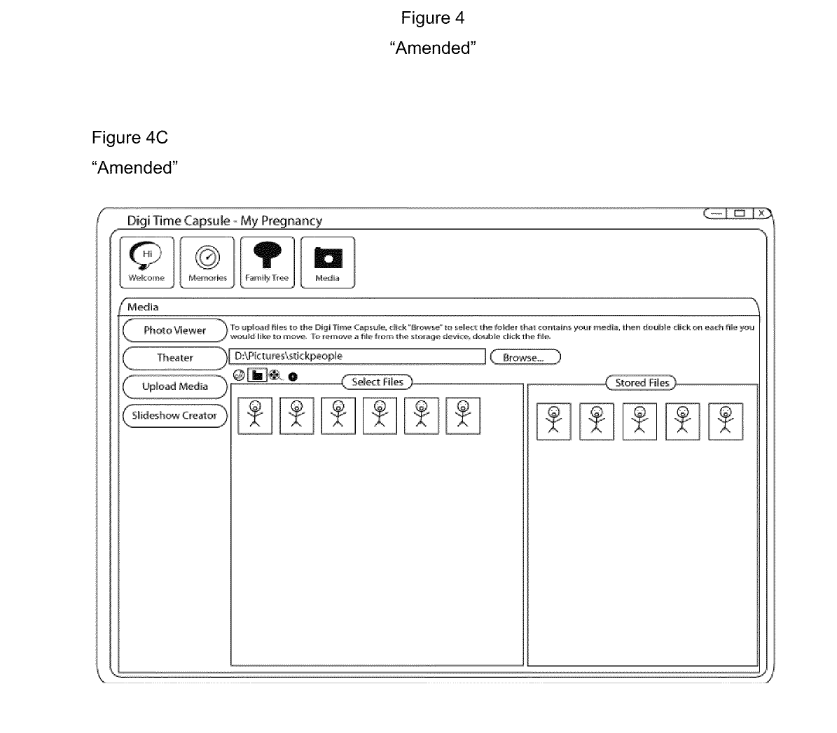

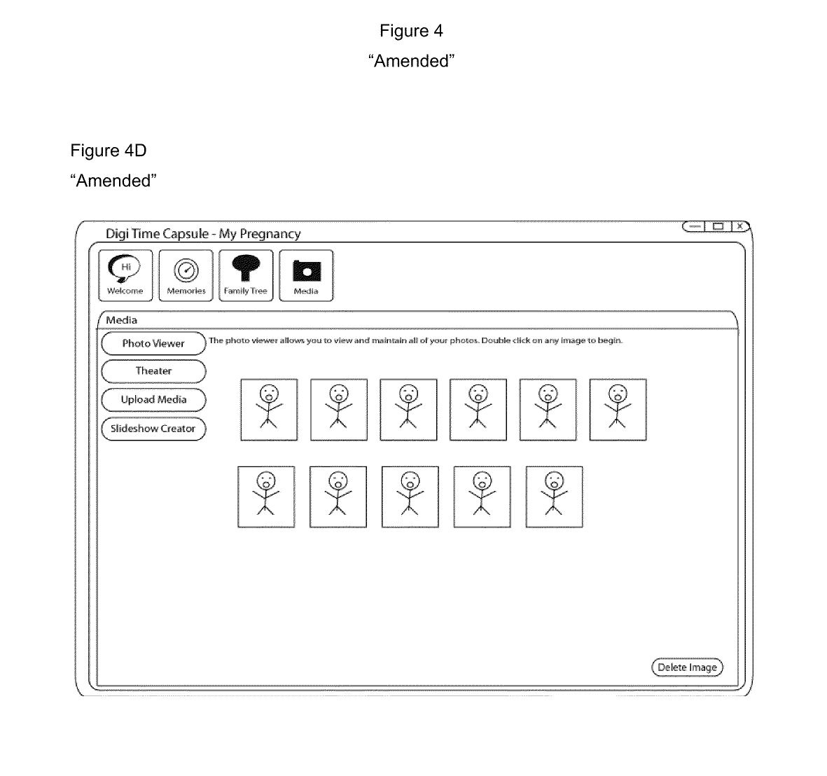

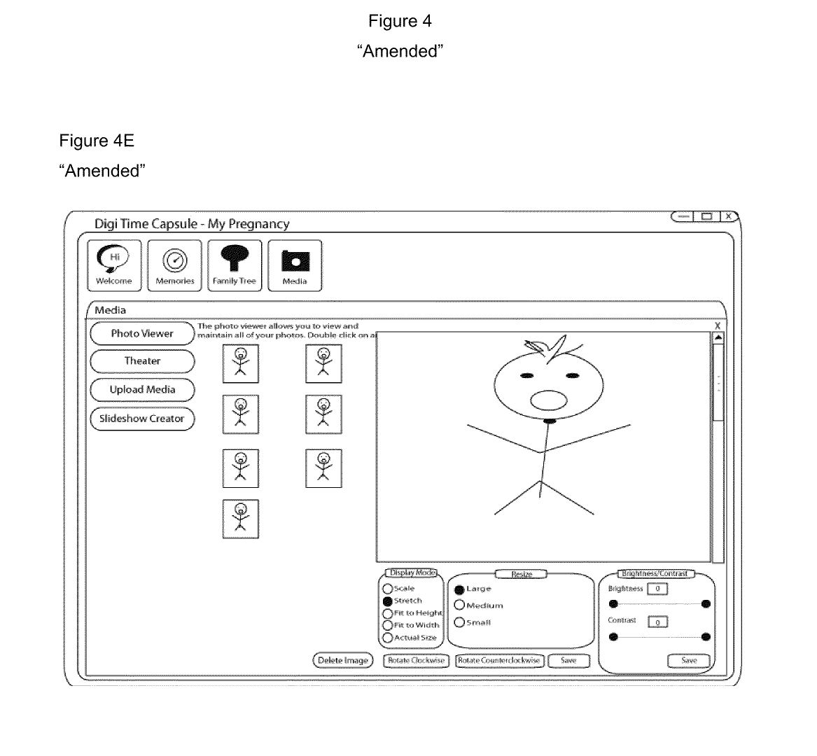

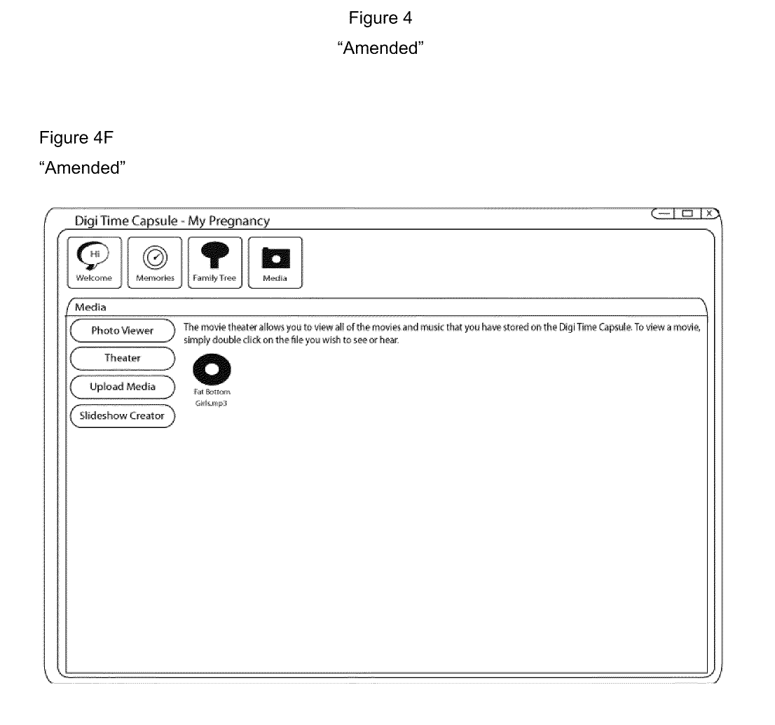

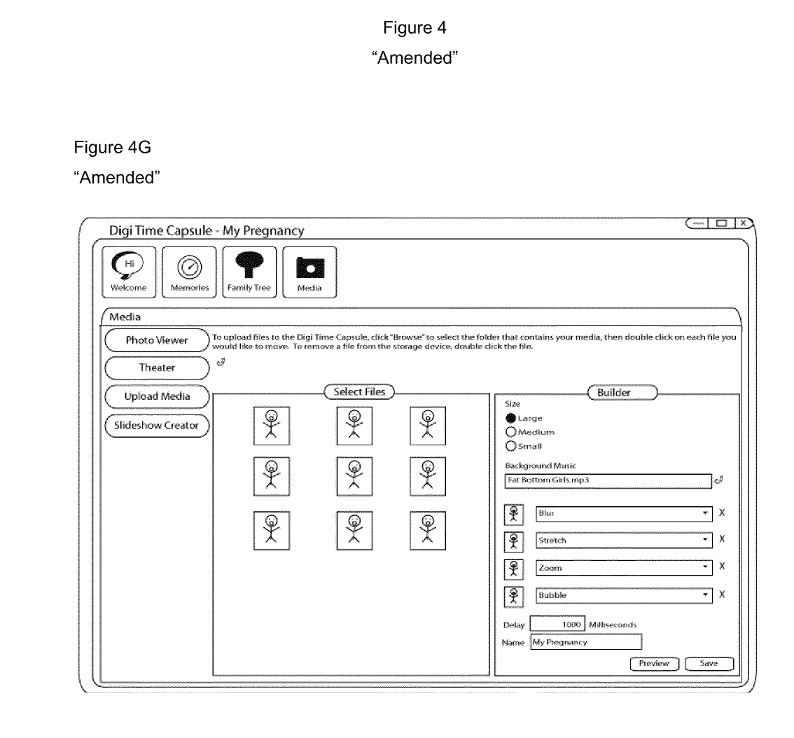

FIG. 4: Software screen shots of the “Media” function of the software

FIG. 4: Allows users to upload photo's, audio files such as music, video files and scanned documents to their Time Capsule. This section of the software also allows users to edit photos, playback any audio or video files and create their own video from the uploads they have added to the software.

FIG. 4A. Uploading Media to the Time Capsule. Users Choose the Media Icon at the top of the software screen. They are then presented with 4 subtopics to the left: Photo Viewer, Theatre, Upload Media and Slideshow creator. Users choose the “Upload Media” selection and are taken to a screen that allows them to choose the type of media they would like to upload; photo, video or audio. (4B) Users choose the browse button, find their media on their computer and select ok. (4C) Their media is then presented in the form of thumbnails on the screen. (4C) To include media into the time capsule, users simply double click on the media to be included and the software will send the media to the right portion of the screen.

FIG. 4D. Viewing Uploaded Photos. Users Choose the Media Icon at the top of the software screen. They are then presented with 4 subtopics to the left: Photo Viewer, Theatre, Upload Media and Slideshow creator. Users choose the “Photo Viewer” selection and are taken to a screen that shows them all of the photos they currently have in their time capsule.

FIG. 4E. Editing Photos. Users Choose the Media Icon at the top of the software screen. They are then presented with 4 subtopics to the left: Photo Viewer, Theatre, Upload Media and Slideshow creator. Users choose the “Photo Viewer” selection and are taken to a screen that shows them all of the photos they currently have in their time capsule. To edit a photo, users simply double click on the photo they would like to render. The photo is enlarged and users are presented with adjust options that include: Display mode, resize, brightness, contrast, delete image and rotate image. Users can then save any adjustments made and their edited photo will be added to the “photo viewer” along with the original image.

FIG. 4F. Theater. The theater function of the Media, simply stores any video and audio uploads. The theater also stores any videos made using the time capsule software. To playback any of the items, users simply double click on the media of their choice.

FIG. 4G. Creating a Video of Your Time Capsule. At the end of the user's journey, or at any time during their journey, users can create a single self-playing video of their photo and audio uploads. Users Choose the Media Icon at the top of the software screen. They are then presented with 4 subtopics to the left: Photo Viewer, Theatre, Upload Media and Slideshow creator. Users choose the “Slideshow creator”. Users are then shown all of their photo uploads. They double click on any of the photos they would like added to their video. All selected photos appear to the right. Users are then presented with options for each photo to add transition effects. Users are also presented with the option to add music to the background of the video. Once the user has added all the photos they want, they can either preview their video first, or go directly to saving it. The video will then be saved and viewable in the “Theatre” function of the “Media”.

What is claimed is:

1. A “no download”, interactive, auto-save and store Software program that captures life journeys (i.e. pregnancy, baby book, school years, wedding, grandchildren, friends, etc.) though the users' ability to upload and edit journey capturing photos, videos, music, audio messages and scanned documents; answering hundreds of pre-written time capsule questions; creating a dynamic family tree to include marriages, birth, member photos, death record, and other information as input by the user; capturing physical changes pertaining to a specific journey through photo place holders placed throughout the software. The final user interface allows users to compile their music, photos and scanned document uploads into a single self-playing movie file to write to CD or publish to networking sites such as Facebook and My Space or directly upload to personal websites. Movies once compiled are also saved onto the USB drive. The software does not need to be downloaded as the software is run from the USB drive. All user input is automatically saved directly to the software, so user will never lose their information should their computer crash. The Digi Time Capsule complete product includes the software, a time capsule shaped USB drive (Exhibit A) and a keep sake tin (Exhibit B) to store said USB drive. The software has a safety export feature to allow users to export their time capsule to an alternate storage device. The Digi Time Capsule complete product includes the software, a time capsule shaped USB drive (Exhibit A) and a keep sake tin (Exhibit B) to store said USB drive.
